(19) United States
(12) Patent Application Publication
(10) Pub. No.: US 2013/0155674 A1
(43) Pub. Date: Jun. 20, 2013

(54) LIGHT-EMITTING DEVICE LAMP

(71) Applicant: SAMSUNG ELECTRONICS CO., LTD., Suwon-si (KR)

(72) Inventors: Dae-yeop PARK, Hwaseong-si (KR); Yun-whan NA, Suwon-si (KR); Ki-hong MOON, Suwon-si (KR)

(73) Assignee: SAMSUNG ELECTRONICS CO., LTD., Suwon-si (KR)

(21) Appl. No.: 13/684,635

(22) Filed: Nov. 26, 2012

(30) Foreign Application Priority Data
Dec. 15, 2011 (KR) 10-2011-0135769

(51) Int. Cl. F21V 29/00; F21V 3/00

(52) U.S. Cl. CPC F21V 29/004; F21V 3/005
USPC 362/235; 362/249.01

(57) ABSTRACT

A light-emitting device lamp includes a light-emission unit including one or more light-emitting elements; a power circuit unit supplying a power to the light-emission unit; a heat radiation unit having the light-emission unit mounted therein and radiating heat that is generated by the light-emission unit; and a housing contacting and surrounding a portion of an outer circumference of the heat radiation unit and transmitting heat generated by the power circuit unit to the heat radiation unit.

### CROSS-REFERENCE TO RELATED PATENT APPLICATION

This application claims priority from Korean Patent Application No. 10-2011-0135769, filed on Dec. 15, 2011, in the Korean Intellectual Property Office, the disclosure of which is incorporated herein in its entirety by reference.

### BACKGROUND

1. Field

Apparatuses consistent with exemplary embodiments relate to a light-emitting device, lamp, and more particularly, to a light-emitting device lamp having an improved heat radiation performance.

2. Description of the Related Art

In general, a light-emitting device such as a light-emitting diode indicates a semiconductor device capable of realizing light of various colors by forming a light-emission source via a P-N junction of a compound semiconductor. The light-emitting device is the semiconductor device that converts electric energy into light energy, is formed as a compound semiconductor that emits light with a particular wavelength according to an energy band gap, and is widely used in optical communication, a display such as a computer monitor, a back light unit (BLU) for a liquid crystal display (LCD), lightings, or the like.

Recently, a light-emitting device lamp that replaces an incandescent lamp is being supplied. However, the light-emitting device lamp emits a large amount of light, such that it emits a considerably large amount of heat radiation. Thus, a lifetime of the light-emitting device lamp may be short unless the heat radiation amount is efficiently controlled. In order to control the heat radiation amount, heat radiation equipment such as a fan may be mounted in the light-emitting device lamp. However, the compulsory heat radiation equipment may cause an additional problem such as an increase in material cost.

### SUMMARY

Exemplary embodiments provide a light-emitting device lamp having an improved heat radiation performance.

According to an aspect of exemplary embodiments, there is provided a light-emitting device lamp including a light-emitter comprising one or more light-emitting elements; a power circuit which supplies a power to the light-emitter; a heat radiation unit which has the light-emitter mounted therein and radiates heat that is generated by the light-emission unit; and a housing which contacts and surrounds a portion of an outer circumference of the heat radiation unit and transfers heat generated by the power circuit to the heat radiation unit.

The housing may be formed of a thermal conductive resin material.

The thermal conductive resin material may be formed of a material in which heat conductive fillers are distributed in a polymer.

The heat conductive fillers may include at least one particle selected from the group comprising carbon nanotube, graphene, titanium oxide, zinc oxide, zirconium oxide, aluminum nitride, and aluminum oxide.

A non-conductive layer may be further formed on a region of the housing which is externally exposed.

The heat radiation unit may be formed by coating heat emission pigments to one from among a thermal conductive metal material and a resin material.

The heat emission pigments may include at least one material selected from the group comprising ITO, SnO₂, ZnO, IZO, carbon nanotube, and graphene.

At least one from among the heat radiation unit and the housing may be coated with black-based pigments.

The heat radiation unit may include a mount part in which the light-emitter is mounted; a heat radiation body that is connected to the mount part and surrounds a portion of the housing; and a plurality of heat radiation pins that are disposed on a side of the heat radiation body and are radially arrayed with respect to a central axis of the light-emitting device lamp.

The housing may include a body contacting part that houses the power circuit and contacts the heat radiation body; and a pin contacting part that is connected to the body contacting part and that contacts and surrounds portions of the plurality of heat radiation pins.

One or more grooves may be formed in a top portion of the body contacting part, and one or more through holes corresponding to the one or more grooves may be formed in regions of the mount part, whereby the body contacting part and the mount part may be combined by using at least one screw.

Regions of the heat radiation pins which contact the pin contacting part may be stepped, whereby an outer circumference of the pin contacting part and outer circumferences of the plurality of heat radiation pins may be connected.

The light-emitting device lamp may further include a lamp cover that covers the heat radiation unit, and the heat radiation unit may include a cover contacting part that is formed on an upper portion of the heat radiation unit and contacts a side surface of the lamp cover.

A coupling groove to which the lamp cover is coupled may be formed in the side of the heat radiation body, and a projection coupled to the coupling groove may be formed on an end of the lamp cover.

The lamp cover may include a radiation angle adjuster which adjusts a radiation angle of light emitted from the light-emitter.

The lamp cover may be formed of a light-transmitting material having a thermal conductivity.

The lamp cover may include a light-transmitting cover and one or more thermal conductive layers that are formed on an outer circumference of the light-transmitting cover.

The one or more thermal conductive layers may include at least one material selected from the group comprising ITO, SnO₂, ZnO, IZO, carbon nanotube, and graphene.

The lamp cover may be formed of a light-transmitting ceramic material of which thermal conductivity is equal to or greater than 9 W/m·K⁻¹.

The light-transmitting ceramic material may include at least one material selected from the group comprising alumina, PLZT, CaF₂, Y₂O₃, YAG, polycrystalline ALON, and MgAl₂O₄.

### BRIEF DESCRIPTION OF THE DRAWINGS

The above and other features will become more apparent by describing in detail exemplary embodiments with reference to the attached drawings in which:

FIG. 1 is an exploded perspective view of a light-emitting device light-emitting device lamp according to an exemplary embodiment;

FIG. 2 is a cross-sectional side view of the light-emitting device lamp of FIG. 1;

FIG. 3 is a rear view of the light-emitting device lamp of FIG. 1;

FIG. 4 is a cross-sectional view of an example in which a housing and a heat radiation unit are combined in the light-emitting device lamp of FIG. 1;

FIG. 5 is a diagram illustrating a contact structure between the housing and the heat radiation unit in the light-emitting device lamp of FIG. 1;

FIG. 6 is a cross-sectional view illustrating another structure of the housing according to an exemplary embodiment;

FIG. 7 is a diagram illustrating a combination structure of a light-emitting device cover and the heat radiation unit in the light-emitting device lamp of FIG. 1;

FIG. 8 is a diagram illustrating a structure of the heat radiation unit in the light-emitting device lamp of FIG. 1; and

FIG. 9 is a cross-sectional view of a lamp cover according to an exemplary embodiment.

### DETAILED DESCRIPTION OF EXEMPLARY EMBODIMENTS

Hereinafter, exemplary embodiments will be described in detail with reference to the attached drawings. In the drawings, like reference numerals in the drawings denote like elements, and the size of each component may be exaggerated for clarity.

Expressions such as “at least one of,” and “at least one from among” when preceding a list of elements, modify the entire list of elements and do not modify the individual elements of the list.

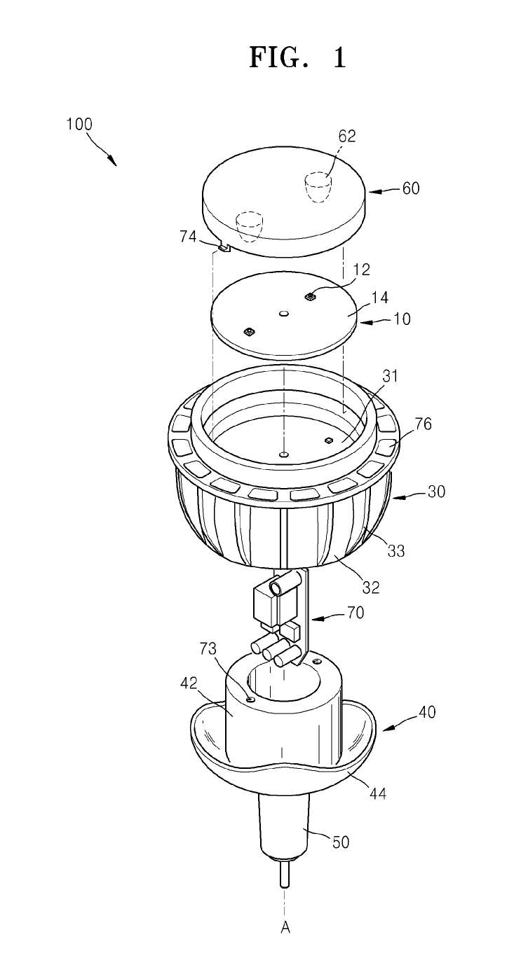

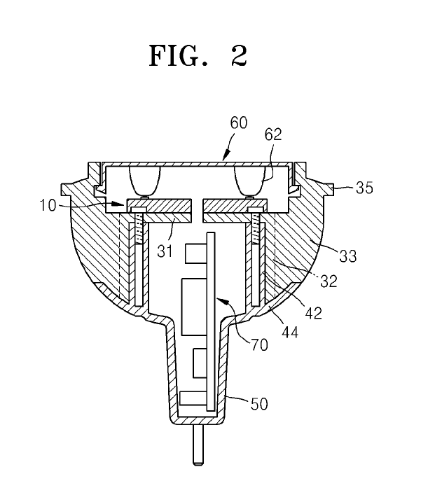

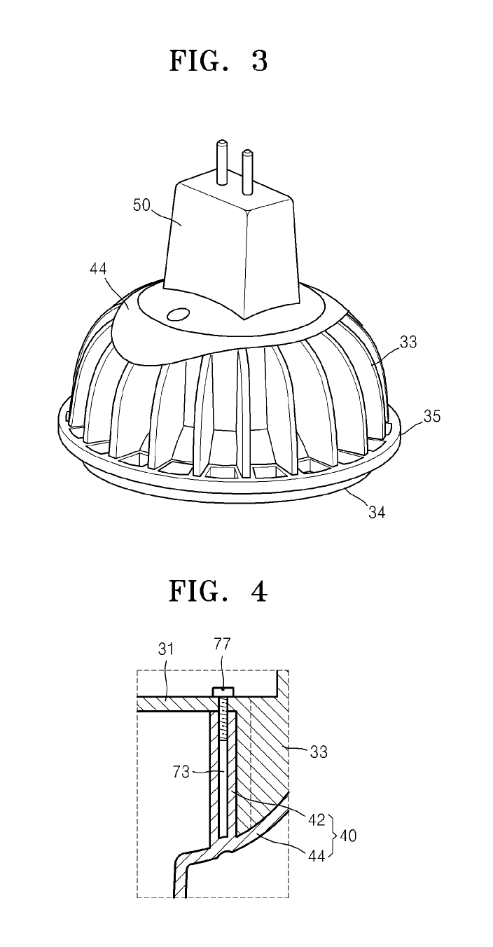

FIG. 1 is an exploded perspective view of a light-emitting device lamp 100 according to an exemplary embodiment. FIG. 2 is a cross-sectional side view of the light-emitting device lamp 100 of FIG. 1. FIG. 3 is a rear view of the light-emitting device lamp 100 of FIG. 1. The light-emitting device lamp 100 of FIGS. 1 through 3 is an example of an light-emitting device lamp (e.g., a PAR series and an MR series) for replacing a halogen lamp.

Referring to FIGS. 1 through 3, the light-emitting device lamp 100 includes a light-emission unit 10 including one or more light-emitting elements 12, a heat radiation unit 30 having the light-emission unit 10 mounted therein and radiating heat from the light-emission unit 10, a power circuit unit 70 supplying a power to the light-emission unit 10, and a housing 40 contacting and surrounding an outer surface of the heat radiation unit 30 and delivering heat, which is generated by the power circuit unit 70, to the heat radiation unit 30.

The light-emission unit 10 may include the one or more light-emitting elements 12 and a circuit substrate 14 on which the one or more light-emitting elements 12 that emit light are mounted. The light-emitting element 12 may be mounted on the circuit substrate 14 in the form of a light-emitting device package formed by packaging a light-emitting element chip by using a lead frame, a mold frame, phosphors, and a light-transmitting filling material according to a pre-mold method. Also, the light-emitting element 12 may be mounted on the circuit substrate 14 in the form of a phosphor-coated light-emitting device chip according to a wire bonding method or a flip-chip-bonding method. The circuit substrate 14 may include a metal substrate or a metal core so as to improve a heat radiation performance.

The power circuit unit 70 supplies power to the light-emission unit 10 and electrically connects the circuit substrate 14 and a socket unit 50 that receives the power from an external power source. A driving circuit (not shown) is formed in the power circuit unit 70 so as to drive the light-emitting element 12 by using electric energy supplied via the socket unit 50. When the power circuit unit 70 is driven, heat is also generated, and by radiating the heat, the light-emitting device lamp 100 may have a long lifetime.

The heat radiation unit 30 may function to externally radiate heat that is generated by the light-emission unit 10 and may have a shape that is exposed to air and has a large heat emission area. For example, the heat radiation unit 30 may include a mount part 31 in which the circuit substrate 14 having the light-emitting element 12 is mounted; a heat radiation body 32 that extends from the mount part 31 and is surrounded by a portion of the housing 40; and a plurality of heat radiation pins 33 that are disposed on the side of the heat radiation body 32 and that are radially arrayed with respect to a central axis of the light-emitting device lamp 100. The mount part 31, the radiation body 32, and the heat radiation pins 33 may be formed as one body.

The mount part 31 may have a round and flat plate shape. In the mount part 31, one or more first through holes (not shown) via which a wire (not shown) for connecting the circuit substrate 14 and the power circuit unit 70 passes may be formed. Also, in the mount part 31, one or more second through holes (not shown) via which a screw for fixing the heat radiation unit 30 to the housing 40 passes may be formed.

The heat radiation body 32 may have a cylindrical shape. However, the cylindrical shape of the heat radiation body 32 is an example and thus a shape of the heat radiation body 32 may be one of various shapes including a polygonal-pillar shape.

Also, the heat radiation pins 33 that are radially arrayed with respect to a central axis A of the light-emitting device lamp 100 may be disposed on the side of the heat radiation body 32. The heat radiation pin 33 may have a partially oval shape portion that may contact the heat radiation body 32 while vertically extending from the heat radiation body 32. The plurality of heat radiation pins 33 may be arranged.

The plurality of heat radiation pins 33 allow high-temperature heat delivered from the light-emitting element 12 to the heat radiation body 32 to be conducted and then to be externally radiated, by expanding a superficial area that contacts air. In the radial array of the plurality of heat radiation pins 33, a density is lower in an open outer space than a compact space of a central area, so that the radial array of the plurality of heat radiation pins 33 may allow fast heat radiation according to a principle in which high-temperature heat moves from a high-density space to a low-density space.

The heat radiation unit 30 may be formed of a metal material such as aluminum (Al), copper (Cu), or the like that have an excellent heat conductivity. Alternatively, the heat radiation unit 30 may be formed of a resin material, other than the metal material, which has an excellent heat conductivity. Also, the heat radiation unit 30 may be formed by additionally coating heat emission pigments to the metal material or the resin material. The heat emission pigments may include at least one material selected from the group comprising ITO, SnO₂, ZnO, IZO, carbon nanotube, and graphene. Also, the heat radiation unit 30 may be coated with black-based pigments. By using the black-based pigments, an effect of an easy thermal conductivity and heat radiation may be achieved without separately arranging equipment or incurring additional costs.

The housing 40 houses the power circuit unit 70 and is connected to the heat radiation unit 30 and the socket unit 50. In the present exemplary embodiment, the housing 40 and the socket unit 50 are formed as one body but one or more exemplary embodiments are not limited thereto. The housing 40 may include the body contacting part 42 that houses the power circuit unit 70 and contacts the heat radiation body 32, and a pin contacting part 44 that is connected to the body contacting part 42 and the socket unit 50 while the pin contacting part 44 contacts and surrounds portions of the plurality of heat radiation pins 33. One or more first coupling grooves 73 to which the heat radiation unit 30 is combined may be formed in a top portion of the body contacting part 42.

FIG. 4 is a cross-sectional view of an example in which the housing 40 and the heat radiation unit 30 are combined in the light-emitting device lamp 100 of FIG. 1. As illustrated in FIG. 4, the first coupling grooves 73 are formed in the top portion of the body contacting part 42, and the second through holes are formed in regions of the mount part 31 which correspond to the first coupling grooves 73. Thus, because a screw 77 is coupled to the first coupling groove 73 via the second through hole, the body contacting part 42 and the mount part 31 may be combined.

When power is supplied to the light-emitting element 12, heat is generated not only by the light-emitting element 12 but also generated by the power circuit unit 70 that drives the light-emitting element 12. Thus, it is necessary to radiate the heat generated by the power circuit unit 70. In order to deliver the heat generated by the power circuit unit 70 to the heat radiation unit 30, the housing 40 may be formed of a material having a thermal conductivity. For example, the housing 40 may be formed of a thermal conductive resin or the like. Also, the thermal conductive resin may be formed of a material in which heat conductive fillers are distributed in a polymer. The heat conductive fillers may include at least one particle selected from the group comprising graphene, titanium oxide, zinc oxide, zirconium oxide, aluminum nitride, and aluminum oxide.

The heat generated by the power circuit unit 70 may be delivered to the heat radiation unit 30 via the housing 40, a maximally-increased contact area between the housing 40 and the heat radiation unit 30.

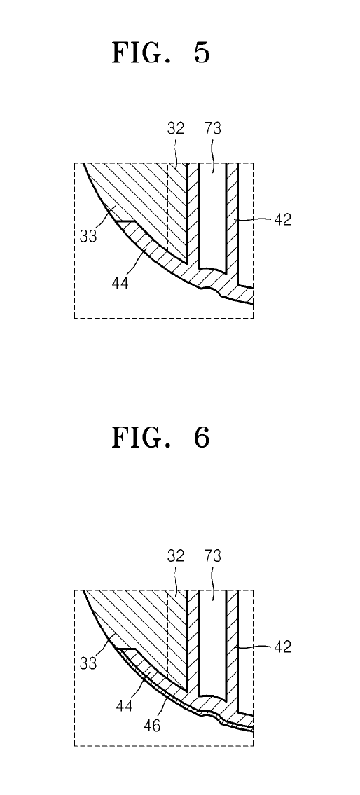

FIG. 5 is a diagram illustrating a contact structure between the housing 40 and the heat radiation unit 30 in the light-emitting device lamp 100 of FIG. 1. As illustrated in FIG. 5, the body contacting part 42 of the housing 40 contacts the heat radiation body 32. Thus, heat generated by the housing 40 may be easily transferred to the heat radiation unit 30.

The pin contacting part 44 of the housing 40 may contact the heat radiation pins 33 of the heat radiation unit 30. As illustrated in FIG. 5, an inner circumference of the pin contacting part 44 may contact outer circumferences of the heat radiation pins 33. If the pin contacting part 44 covers too large a portion of the outer circumferences of the heat radiation pins 33, external heat radiation may be prevented. Thus, the pin contacting part 44 may partially cover the outer circumferences of the heat radiation pins 33 while the partial coverage may minimize the external heat radiation. Also, regions of the heat radiation pins 33, which contact the pin contacting part 44, may be stepped, so that an outer circumference of the pin contacting part 44 and the outer circumferences of the heat radiation pins 33 may be continuously connected. By doing so, a contact area between the heat radiation pins 33 and the pin contacting part 44 may be maximally increased.

Also, at least one non-conductive layer may be formed on a region of the housing 40 which is externally exposed.

FIG. 6 is a cross-sectional view illustrating another structure of the housing 40 according to an exemplary embodiment. As illustrated in FIG. 6, a non-conductive layer 46 may be formed on a region of the housing 40 which is externally exposed. As described above, the housing 40 is formed of a thermal conductive layer, so that heat generated by the power circuit unit 70 is delivered to the heat radiation unit 30. However, because the non-conductive layer 46 is formed on the externally-exposed region of the housing 40, a user may easily manipulate the light-emitting device lamp 100 while the light-emitting device lamp 100 generates heat.

The light-emitting device lamp 100 may further include a lamp cover 60 that covers the light-emission unit 10, including the light-emitting element 12 and the circuit substrate 14. The lamp cover 60 may be a cylindrical light-transmitting cover having an empty inner space. Also, the lamp cover 60 may be a milky cover for diffusion of light. In the lamp cover 60 according to the present exemplary embodiment, radiation angle adjusting units 62 may be formed to adjust a radiation angle of light emitted from the light-emitting element 12. In the present exemplary embodiment, the radiation angle adjusting units 62 are formed as lenses but one or more exemplary embodiments are not limited thereto. For example, although not illustrated, the radiation angle adjusting units 62 may be formed as reflecting units that radiate light that is emitted from the light-emitting element 12 at a desired radiation angle.

A projection 74 may be formed on an end of a side surface 64 of the lamp cover 60 of the light-emitting device lamp 100.

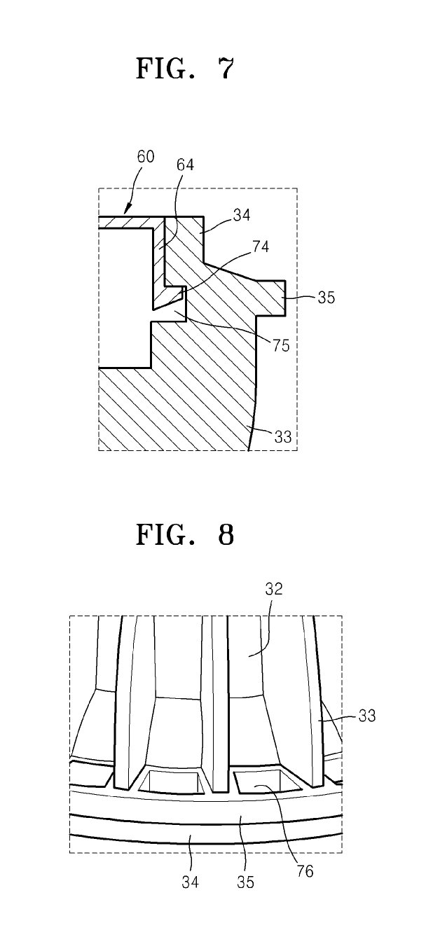

FIG. 7 is a diagram illustrating a combined structure of a light-emitting device cover and the heat radiation unit 30 in the light-emitting device lamp 100 of FIG. 1. As illustrated in FIG. 7, the projection 74 having a screw shape may be formed on the end of the side surface 64 of the lamp cover 60, and a second coupling groove 75 to which the lamp cover 60 is coupled may be formed in a top region of the heat radiation unit 30. The second coupling groove 75 may have a complementary shape to the projection 74. In this manner, the projection 74 of the lamp cover 60 is coupled to the second coupling groove 75 of the heat radiation unit 30, so that the lamp cover 60 and the heat radiation unit 30 are combined. The combination method for the lamp cover 60 and the heat radiation unit 30 is not limited to the aforementioned method, and thus various methods including a snap-fit combination method may be applied thereto.

For a lamp to have a high efficiency and a long lifetime although an output of the lamp increases, it is necessary to assure a sufficient heat radiation performance in a limited size and shape. In this regard, in order to radiate heat generated by the light-emitting element 12, the lamp cover 60 may be formed of a material capable of radiating heat. In general, a thermal conductivity of a glass material, a polycarbonate (PC)-based resin material, and a polymethyl methacrylate (PMMA)-based resin material is about 0.3˜3 W/m·K⁻¹, which is considerably inadequate for a material to radiate the heat generated by the light-emitting element 12. In this regard, the light-emitting device lamp 100 may include the lamp cover 60 that is formed of a light-transmitting material of which thermal conductivity is equal to or greater than 9 W/m·K⁻¹. The thermal conductivity of the lamp cover 60 is about 3 to 30 times higher than a thermal conductivity of a lamp cover formed of a general transparent resin material.

Alternatively, the lamp cover 60 may be formed of a light-transmitting ceramic material of which thermal conductivity is equal to or greater than 9 W/m·K⁻¹. For example, an alumina (Al₂O₃) molded body has light-transmittance and its thermal conductivity is significantly higher than a thermal conductivity of a general light-transmitting material. For example, a thermal conductivity of α-AL₂O₃ is about 33 W/m·K⁻¹ at 25° C. Thus, α-AL₂O₃ may be used as a material for the lamp cover 60.

However, another example of light-transmitting material may be used, as the lamp cover 60 is not limited to alumina. For example, Lead Lanthanum Zirconate titanate (PLZT) having an optoelectronic property and used as an optical communication material, and CaF₂, Y₂O₃, YAG, and polycrystalline ALON, MgAl₂O₄, or the like that are high quality transparent ceramic materials having a high cubic crystal, may be used as materials for the lamp cover 60. ALON is formed by adjusting a composition ratio of Al₂O₃ and AlN, and an addition amount of Y₂O₃, BN, CaO, or MgO, which is used as a sintering agent, and in this regard, it is possible to find a material having high light-transmittance and high thermal conductivity according to the composition ratio and the addition amount. A composition ratio of ALON developed by Surmet Corporation is AL_{23-1/3x}O₂₇₊ₓN₅₋ₓ (0.49<x<2), a thermal conductivity of ALON is 9.7 W/m·K⁻¹ at 75° C., a thermal conductivity of MgAl₂O₄ is 25 W/m·K⁻¹ at 25° C., and light transmittance of MgAl₂O₄ having a thickness of 4 mm is 76% of wavelength light with 650 nm.

In order to facilitate a heat transmittance between the heat radiation unit 30 and the lamp cover 60, the heat radiation unit 30 and the lamp cover 60 may contact each other. As illustrated in FIG. 7, a cover contacting part 34 that contacts and covers the side surface 64 of the lamp cover 60 may be formed at an upper portion of the heat radiation unit 30. By doing so, heat may be maximally transferred from the heat radiation unit 30 to the lamp cover 60.

Also, the heat radiation unit 30 may further include a heat radiation ring 35 connected to the heat radiation body 32, the heat radiation pin 33, and the cover contacting part 34.

FIG. 8 is a diagram illustrating a structure of the heat radiation unit 30 in the light-emitting device lamp 100 of FIG. 1. As illustrated in FIG. 8, the heat radiation body 32, the heat radiation pin 33, and the cover contacting part 34 are connected to each other via the heat radiation ring 35. By doing so, heat is uniformly distributed to an entire region of the heat radiation unit 30. Also, in order to activate air convection between the heat radiation pin 33 and the cover contacting part 34, the heat radiation ring 35 may have a plurality of openings 76 that correspond to spaces between the heat radiation pins 33.

Alternatively, the lamp cover 60 may be formed by forming a thermal conductive layer on a common cover.

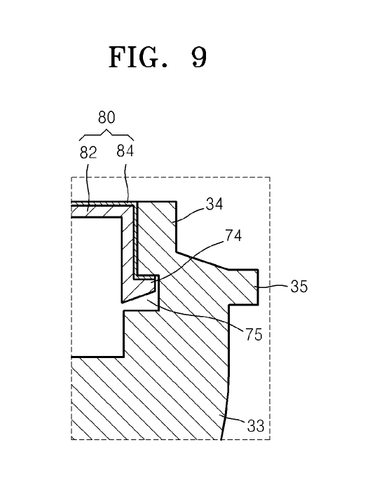

FIG. 9 is a cross-sectional view of a lamp cover 80 according to an exemplary embodiment. As illustrated in FIG. 9, the lamp cover 80 may include a cover 82 formed of a light-transmitting material, and a thermal conductive layer 84 having one or more layers and formed on an outer circumference of the cover 82. The thermal conductive layer 84 contacts the cover contacting part 34 of the heat radiation unit 30. By doing so, a heat transmittance from the heat radiation unit 30 to the lamp cover 80 is achieved by a direct contact between the thermal conductive layer 84 and the heat radiation unit 30. In order to increase a heat transmittance area, as illustrated in FIG. 9, the thermal conductive layer 84 may be formed to a projection of the lamp cover 80, and the projection may be in surface contact with the second coupling groove 75.

Heat that is generated by the power circuit unit 70 may be delivered to the heat radiation unit 30, because the housing 40 is formed of a thermal conductive material and a contact area between the housing 40 and the heat radiation unit 30 is increased. Also, by forming the lamp cover 80 with a thermal conductive material and by increasing a contact area between the heat radiation unit 30 and the lamp cover 80, the lamp cover 80 may also perform a heat radiation function. By doing so, without employing a compulsory cooling method using a fan or the like, it is possible to implement the light-emitting device lamp 100 having a high efficiency and a long lifetime, and satisfying a specification of a traditional lighting appearance.

In the aforementioned exemplary embodiments, a light-emitting device lamp for replacing a halogen lamp is described as an example but the scope of the one or more exemplary embodiments are not limited thereto. Thus, it is obvious that the aforementioned exemplary embodiments may also be applied to an incandescent-type light-emitting device lamp.

In a light-emitting device lamp according to the one or more exemplary embodiments, a housing is formed of a thermal conductive material, so that heat generated by the housing is delivered to a heat radiation unit.

Also, by maximally increasing the contact area between the housing and the heat radiation unit, a heat radiation performance may be improved.

Also, because a lamp cover is formed of a thermal conductive material, the lamp cover may also perform a heat radiation function.

While exemplary embodiments have been particularly shown and described, it will be understood by those of ordinary skill in the art that various changes in form and details may be made therein without departing from the spirit and scope of the present invention as defined by the following claims.

1. A light-emitting device lamp comprising:
light-emission unit comprising one or more light-emitting elements;
a power circuit which supplies a power to the light emission unit;
a heat radiation unit, which comprises the light emission unit mounted therein and radiates heat; and
a housing which contacts and surrounds a portion of an outer circumference of the heat radiation unit and transfers heat generated by the power circuit to the heat radiation unit.

2. The light-emitting device lamp of claim 1, wherein the housing is formed of a thermal conductive resin material.

3. The light-emitting device lamp of claim 2, wherein the thermal conductive resin material is formed of a material in which heat conductive fillers are distributed in a polymer.

4. The light-emitting device lamp of claim 1, wherein a non-conductive layer is formed on a region of the housing which is externally exposed.

5. The light-emitting device lamp of claim 1, wherein the heat radiation unit is formed by coating heat emission pigments to one from among a thermal conductive metal material and a resin material.

6. The light-emitting device lamp of claim 1, wherein at least one from among the heat radiation unit and the housing is coated with black-based pigments.

7. The light-emitting device lamp of claim 1, wherein the heat radiation unit comprises:
a mount part in which the light emission unit is mounted;
a heat radiation body that is connected to the mount part and surrounds a portion of the housing; and
a plurality of heat radiation pins that are disposed on a side of the heat radiation body and are radially arrayed with respect to a central axis of the light-emitting device lamp.

8. The light-emitting device lamp of claim 7, wherein the housing comprises:
a body contacting part that houses the power circuit and contacts the heat radiation body; and
a pin contacting part that is connected to the body contacting part and that contacts and surrounds portions of the plurality of heat radiation pins.

9. The light-emitting device lamp of claim 8, wherein one or more grooves are formed in a top portion of the body contacting part, and one or more through holes corresponding to the one or more grooves are formed in regions of the mount part, whereby the body contacting part and the mount part are combined by using at least one screw.

10. The light-emitting device lamp of claim 8, wherein regions of the plurality of heat radiation pins which contact the pin contacting part are stepped, whereby an outer circumference of the pin contacting part and outer circumferences of the plurality of heat radiation pins are connected.

11. The light-emitting device lamp of claim 1, further comprising a lamp cover that covers the heat radiation unit, and
the heat radiation unit comprises a cover contacting part that is formed on an upper portion of the heat radiation unit and contacts a side surface of the lamp cover.

12. The light-emitting device lamp of claim 11, wherein a coupling groove to which the lamp cover is coupled is formed in the side of the heat radiation body, and a projection coupled to the coupling groove is formed on an end of the lamp cover.

13. The light-emitting device lamp of claim 11, wherein the lamp cover comprises a radiation angle adjuster which adjusts a radiation angle of light emitted from the light emission unit.

14. The light-emitting device lamp of claim 11, wherein the lamp cover is formed of a light-transmitting material having a thermal conductivity.

15. The light-emitting device lamp of claim 11, wherein the lamp cover comprises a light-transmitting cover and one or more thermal conductive layers that are formed on an outer circumference of the light-transmitting cover.
